(19) United States
(12) Patent Application Publication
(10) Pub. No.: US 2017/0316197 A1
(43) Pub. Date: Nov. 2, 2017

(54) USER INTERFACE CONTROL METHOD AND ELECTRONIC DEVICE

(71) Applicants: NANNING FUGUI PRECISION INDUSTRIAL CO., LTD., Nanning (CN); HON HAI PRECISION INDUSTRY CO., LTD., New Taipei (TW)

(72) Inventor: SHAN-SHAN ZHANG, Shenzhen (CN)

(21) Appl. No.: 15/472,291

(22) Filed: Mar. 29, 2017

(30) Foreign Application Priority Data
Apr. 29, 2016 (CN) 201610276847.1

(51) Int. Cl. G06F 21/36; G06F 3/0488

(52) U.S. Cl. CPC G06F 21/36; G06F 3/04883; G06F 3/04886

(57) ABSTRACT

A user interface control method executed in a security-locked electronic device with a touch screen detects an i-th sliding operation on the touch screen, wherein 1≦i≦n. An i-th set of unlocking sub-password is obtained by analyzing a slide starting point, a sliding track, and an ending point of the i-th sliding operation. The i-th set of unlocking sub-password comprises a character corresponding to a key at the starting point and a sliding distance corresponding to the i-th sliding operation. The user interface of the electronic device is unlocked when I sets of unlocking sub-passwords are the same as preset N sets of standard sub-passwords. Positions of the characters in an array of keys in the user interface are adjusted according to the i-th sliding operation.

### CROSS-REFERENCE TO RELATED APPLICATIONS

This application claims priority to Chinese Patent Application No. 201610276847.1 filed on Apr. 29, 2016, the contents of which are incorporated by reference herein.

### FIELD

The subject matter herein generally relates to data security in mobile devices.

### BACKGROUND

Terminals with touch-sensitive displays are popular, as electronic devices, digital photo frames, tablet PCs, and the like. Each of the terminals usually runs a secure application (eg., lock screen application) to prevent the terminal from data theft.

Currently, users can access the terminal by performing corresponding unlocking procedures, such as pressing some preset buttons sequentially on a corresponding unlock interface, or performing a predetermined gesture on a corresponding unlock interface.

However, the above unlocking procedures may be easily cracked because of tracking of previous operations.

### BRIEF DESCRIPTION OF THE DRAWINGS

Implementations of the present technology will now be described, by way of example only, with reference to the attached figures.

FIG. 1 illustrates a block diagram of a first exemplary embodiment of an electronic device.

FIG. 2 illustrates a flowchart of a first exemplary embodiment of a user interface control method.

FIG. 3 illustrates a first array of keys position adjustment in the device of FIG. 1.

FIG. 4 illustrates a second array of keys position adjustment in the device of FIG. 1.

FIG. 5 illustrates a block diagram of a second exemplary embodiment of an electronic device.

FIG. 6 illustrates a flowchart of a second exemplary embodiment of a user interface control method.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

It should be noted that references to “an” or “one” embodiment in this disclosure are not necessarily to the same embodiment, and such references mean “at least one.”

In general, the text “module” as used hereinafter, refers to logic embodied in computing or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or computing modules and may be stored in any type of non-transitory computer-readable medium or other storage device. Some non-limiting examples of non-transitory computer-readable media include CDs, DVDs, BLU-RAY, flash memory, and hard disk drives. The term “comprising”, when utilized, means “including, but not necessarily limited to”; it specifically indicates open-ended inclusion or membership in a so-described combination, group, series and the like.

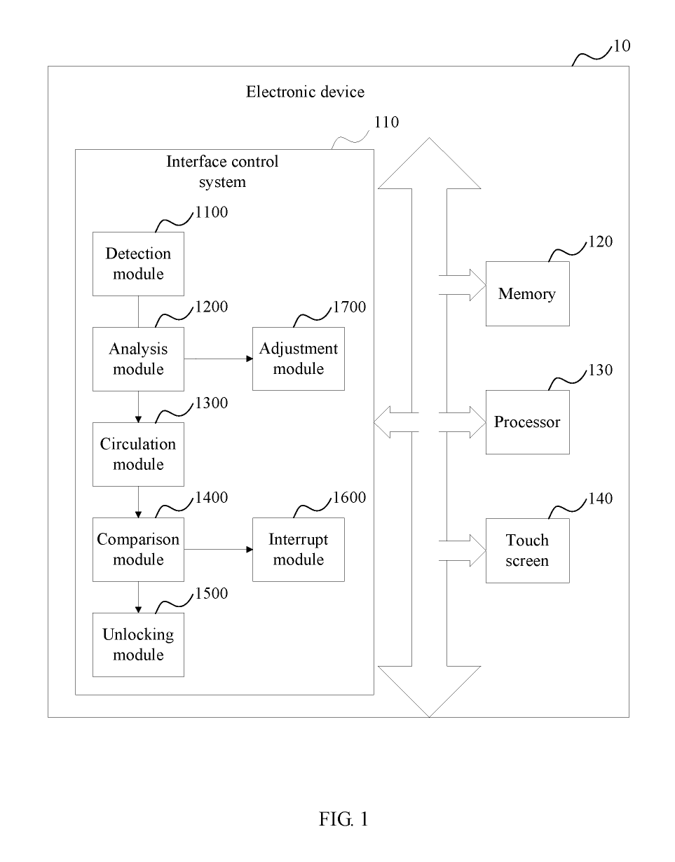

FIG. 1 illustrates a first exemplary embodiment of an electronic device 10. In this embodiment, the electronic device 10 includes an interface control system 110, a memory 120, a processor 130, and a touch screen 140. The interface control system 110 controls the electronic device 10 in response to touch input.

The touch screen 140 displays a user interface. The user interface displays an array of keys when the electronic device 10 is locked. The array includes M*N keys, and each of the keys is corresponding to a character. The touch screen 140 is also used to receive the touch input.

In an embodiment, the array may include twelve keys corresponding to numbers “0”-“9” and symbols “*” and “#”. The twelve keys may be placed in four rows and three columns or other display arrangement.

The electronic device 10 is pre-configured with a standard password for unlocking the user interface. The standard password includes N sets of standard sub-passwords in sequence. Each standard sub-password includes the character of the key and a sliding distance. The interface control system 110 compares data of the touch input with the standard password, and determines that the user interface on the locking condition should be unlocked according to a match.

The interface control system 110 comprises a detection module 1100, an analysis module 1200, a circulation module 1300, a comparison module 1400, an unlocking module 1500, an interrupt module 1600, and an adjustment module 1700. The modules 1100-1700 can include computerized code in the form of one or more programs that are stored in the memory 120, and executed by the processor 130 to provide functions of the interface control system 110. The memory 120 can be a dedicated memory, such as an EEPROM or a flash memory.

The detection module 1100 detects an i-th sliding operation on the touch screen, wherein 1≦i≦n. In this embodiment, the electronic device 10 enters an unlocking mode and the detection module 1100 detects the i-th sliding operation when the interface control system 110 receives an unlocking signal.

The analysis module 1200 analyzes the i-th sliding operation, to obtain an i-th set of unlocking sub-password. In detail, the analysis module 1200 obtains the i-th set of unlocking sub-password by analyzing a starting point, a sliding track, and an ending point of the i-th sliding operation. The i-th set of the unlocking sub-password comprises the character corresponding to the key at the starting point and the sliding distance corresponding to the i-th sliding operation.

The circulation module 1300 stores the i-th set of unlocking sub-password in the memory 120, to obtain I sets of unlocking sub-password. If the detection module 1100 detects a next sliding operation, the circulation module 1300 runs the detection module 1100 and the analysis module 1200.

The comparison module 1400 compares the I sets of unlocking sub-passwords with the N sets of standard sub-passwords in sequence, when the detection module 1100 does not detect a next sliding operation.

The unlocking module 1500 unlocks the user interface of the electronic device 10 when the result of comparison is the same.

The interrupt module 1600 sets failure and resumes the value of the i to 1, when the result is not the same.

The adjustment module 1700 adjusts positions of the characters in the array of keys according to the sliding operation.

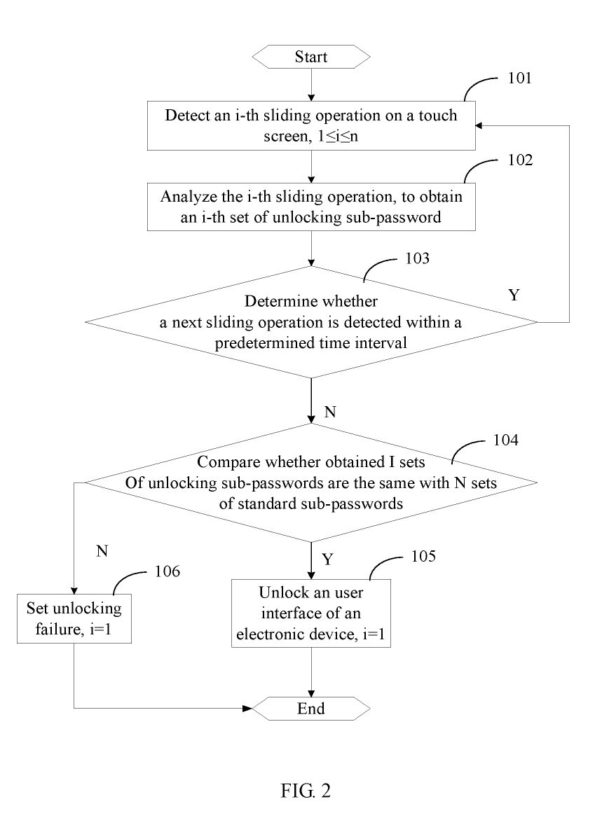

FIG. 2 illustrates a flowchart of a first exemplary embodiment of a user interface control method. The method is operable to be executed in the electronic device 10. The method can begin at block 101.

At block 101, the detection module 1100 detects an i-th sliding operation on the touch screen 140, wherein 1≦i≦n. In this embodiment, the electronic device 10 enters the unlocking mode and the detection module 1100 detects the i-th sliding operation when the interface control system 110 receives an unlocking signal.

At block 102, the analysis module 1200 analyzes the i-th sliding operation, to obtain an i-th set of unlocking sub-password. In detail, the analysis module 1200 obtains the i-th set of unlocking sub-password by analyzing a starting point, a sliding track, and an ending point of the i-th sliding operation. The i-th set of unlocking sub-password comprises the character corresponding to the key at the starting point and the sliding distance corresponding to the i-th sliding operation.

In an embodiment, the sliding distance is a distance in a straight line between the starting point and the ending point. A unit of the sliding distance is a distance between the centers of two adjacent keys.

In an embodiment, the sliding distance is an integer. For example, if the sliding distance is between two and three, the sliding distance is set as two.

In an embodiment, the analysis module 1200 presets a default sliding distance. The default sliding distance is used as the sliding distance when the ending point is outside of the array of keys.

In an embodiment, the analysis module 1200 obtains the sliding direction of the sliding operation according to the starting point, the sliding track, and the ending point.

At block 103, the circulation module 1300 determines whether a next sliding operation is detected within a predetermined time interval. If next sliding operation is detected, the method returns to block 101. If a next sliding operation is not detected, the method proceeds to block 104. Moreover, the circulation module 1300 stores the i-th set of unlocking sub-password in the memory 120, to obtain I sets of unlocking sub-passwords in sequence.

At block 104, the comparison module 1400 compares the obtained I sets of unlocking sub-passwords with the N sets of standard sub-passwords. In this embodiment, if a value of I is different from a value of N, the result of comparison is that they are not the same. If the value of I is the same as the value of N, the comparison module 1400 sequentially compares the obtained I sets of unlocking sub-passwords with the N sets of standard sub-passwords starting with a first set of unlocking sub-password and a first set of standard sub password, until the I-th set of unlocking sub-password is compared with the N-th set of standard sub password. If all of the comparisons show matches, the method proceeds to block 105. If the result is not the same, the method proceeds to block 106.

At block 105, the unlocking module 1500 unlocks the user interface of the electronic device 10 and resumes the value of i to 1.

At block 106, the interrupt module 1600 sets failure to unlock and resumes the value of i to 1.

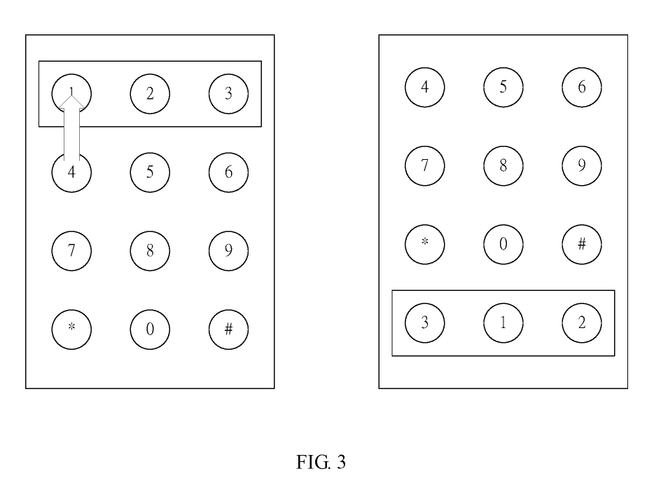

In a preferred embodiment, the user interface has an array of keys (M*N keys). Each key is configured with a character. The adjustment module 1700 adjusts positions of the characters in the array of keys according to the character, the sliding direction, and the sliding distance obtained by the analysis module 1200. In detail, the adjustment module 1700 moves all of the M*N characters to positions corresponding with the sliding direction and the sliding distance. Characters which overflow to the outside of the array of keys are out-of-order filled in rows or columns of vacant keys of the array. FIG. 3 illustrates an array of keys position adjustment. The adjustment module 1700 moves the array of keys up one distance unit according to the character “4”, the sliding direction “up” and the sliding distance “1” obtained by the analysis module 1200. The row “1 2 3” which overflows is filled in at the bottom row of the array in an out-of-order fashion (“3 1 2”).

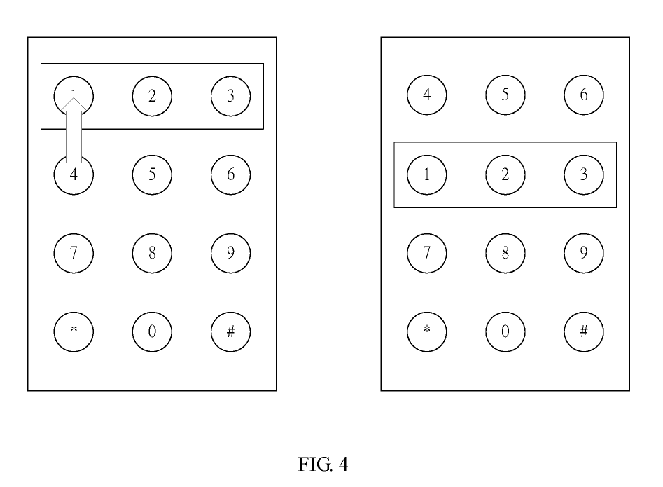

In another preferred embodiment, the adjustment module 1700 adjusts positions of the characters in the array of keys according to the starting point, the ending point, and the sliding direction of the sliding operation. In detail, the adjustment module 1700 exchanges characters of a starting-point row or starting-point column for characters of another row or another column in which the ending point is located. FIG. 4 illustrates a second array of keys position adjustment. The adjustment module 1700 receives the starting point “4”, the sliding direction “up”, and the ending point “1” obtained by the analysis module 1200. The characters of the row “4 5 6” where the starting point “4” is located and the characters of the row “1 2 3” where the ending point “1” is located are exchanged for each other.

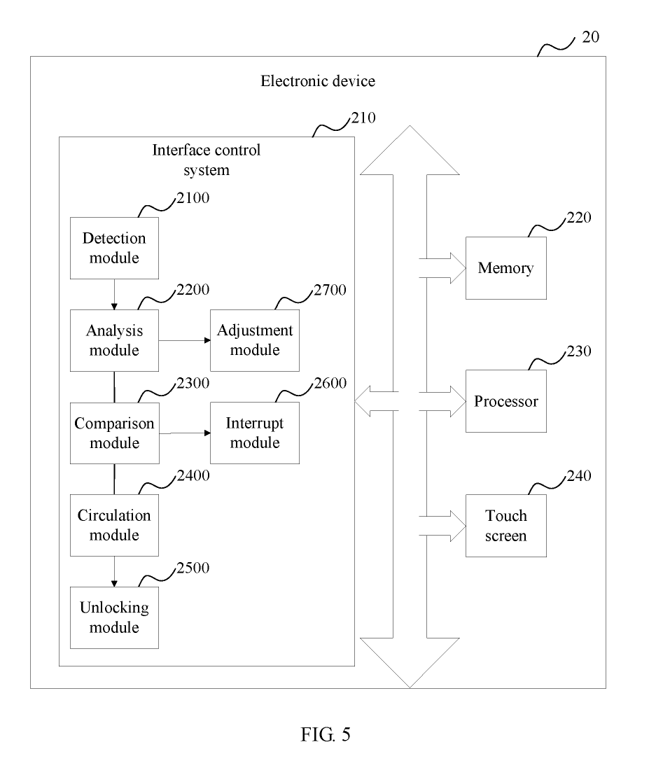

FIG. 5 illustrates a second exemplary embodiment of an electronic device 20. In this embodiment, the electronic device 20 includes an interface control system 210, a memory 220, a processor 230, and a touch screen 240. The interface control system 210 comprises a detection module 2100, an analysis module 2200, a comparison module 2300, a circulation module 2400, an unlocking module 2500, an interrupt module 2600, and an adjustment module 2700. The modules 2100-2700 can include computerized code in the form of one or more programs that are stored in the memory 220, and executed by the processor 230 to provide functions of the interface control system 210. The electronic device 20 is substantially the same in structure as the electronic device 10 in FIG. 1, except that the comparison module 2300 and the circulation module 2400 are respectively not the same as the comparison module 1300 and the circulation module 1400.

The comparison module 2300 compares the i-th set of unlocking sub-password with the i-th set of standard sub-password. In this embodiment, the i-th set of unlocking sub-password is obtained according to the i-th sliding operation, and the i-th set of standard sub-password is obtained from the standard password. If the character and the sliding distance of the unlocking sub-password are the same as the character and the sliding distance of the standard sub-password, the comparison result is the same.

When the comparison result is the same and i<n, the circulation module 2400 cyclically runs the detection module 2100, the analysis module 2200, and the comparison module 2300.

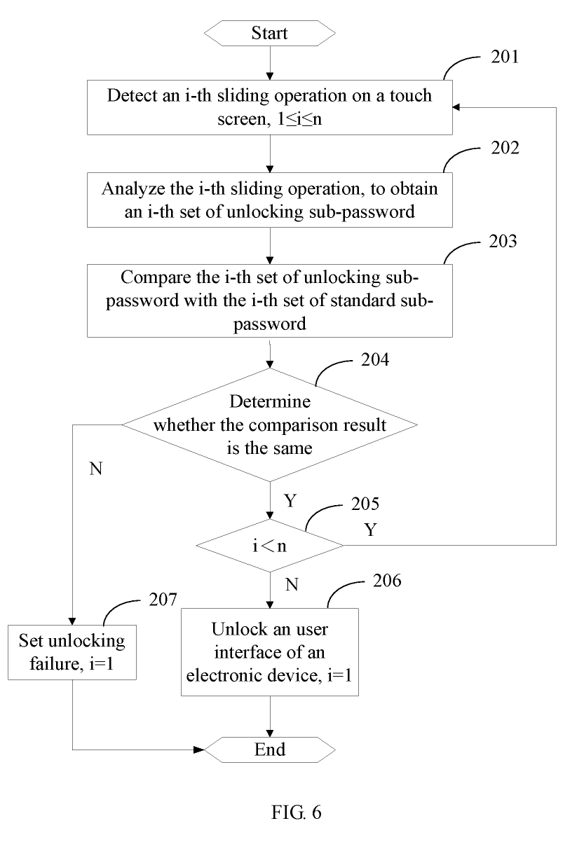

FIG. 6 illustrates a flowchart of a second exemplary embodiment of a user interface control method. The method is operable to be executed in the electronic device 20. The method can begin at block 201.

At block 201, the detection module 2100 detects an i-th sliding operation on the touch screen, wherein 1≦i≦n. In this embodiment, the electronic device 20 enters the unlocking mode and the detection module 2100 detects the i-th sliding operation when the interface control system 210 receives an unlocking signal.

At block 202, the analysis module 2200 analyzes the i-th sliding operation, to obtain an i-th set of unlocking sub-password. The analysis module 2200 obtains the i-th set of unlocking sub-password by analyzing a starting point, a sliding track, and an ending point of the i-th sliding operation. The i-th set of unlocking sub-password comprises the character corresponding to the key at the starting point and the sliding distance corresponding to the i-th sliding operation.

In an embodiment, the sliding distance is a straight line distance between the starting point and the ending point. A unit of the sliding distance is a distance between the centers of two adjacent keys.

In an embodiment, the sliding distance is an integer. For example, if the sliding distance is between two and three, the sliding distance is set as two.

In an embodiment, the analysis module 2200 presets a default sliding distance. The default sliding distance is used as the sliding distance when the ending point is outside of the array of keys.

In an embodiment, the analysis module 2200 obtains a sliding direction of the sliding operation according to the starting point, the sliding track, and the ending point.

At block 203, the comparison module 2300 compares the i-th set of unlocking sub-password with the i-th set of standard sub-password. If the character and the sliding distance of the unlocking sub-password are same as the character and the sliding distance of the standard sub-password, the comparison result is the same.

At block 204, the circulation module 2400 determines whether the comparison result is the same. If the comparison result is the same, the method proceeds to block 205. If the comparison result is not the same, the method proceeds to block 207.

At block 205, the circulation module 2400 determines whether i<n. If i<n, the method returns to block 201. If i is equal to n, the method proceeds to block 206.

At block 206, the unlocking module 2500 unlocks the user interface of the electronic device 20 and resumes the value of i to 1.

At block 207, the interrupt module 2600 sets failure to unlock and resumes the value of i to 1.

In a preferred embodiment, the user interface has an array of keys (M*N keys). Each key is configured with a character. The adjustment module 2700 adjusts positions of the characters in the array of keys according to the character, the sliding direction, and the sliding distance obtained by the analysis module 2200. In detail, the adjustment module 2700 moves all of the M*N characters to corresponding positions in accordance with the sliding direction and the sliding distance. Characters which overflow to the outside of the array of keys are out-of-order filled in rows or columns of vacant keys of the array.

In another preferred embodiment, the adjustment module 2700 adjusts positions of the characters in the array of keys according to the starting point, the ending point, and the sliding direction of the sliding operation. In detail, the adjustment module 2700 exchanges characters of a row or a column in which the starting point is located for characters of another row or another column in which the ending point is located.

It should be emphasized that the above-described embodiments of the present disclosure, including any particular embodiments, are merely possible examples of implementations, set forth for a clear understanding of the principles of the disclosure. Many variations and modifications can be made to the above-described embodiment(s) of the disclosure without departing substantially from the spirit and principles of the disclosure. All such modifications and variations are intended to be included herein within the scope of this disclosure and protected by the following claims.

What is claimed is:

1. A computer-implemented method, executable by a processor of an electronic device with a touch screen, the method comprising:
detecting an i-th sliding operation on the touch screen, wherein 1≦i≦n;
obtaining an i-th set of unlocking sub-password by analyzing a starting point, a sliding track and an ending point of the i-th sliding operation, wherein the i-th set of unlocking sub-password comprises a character corresponding to a key at the starting point and a sliding distance corresponding to the i-th sliding operation;
saving the i-th set of unlocking sub-password until no sliding operation is detected within a predetermined time interval, to obtain I sets of unlocking sub-passwords in sequence;
comparing whether the I sets of unlocking sub-passwords are the same with preset N sets of standard sub-passwords; and
unlocking an user interface of the electronic device when the comparison result is the same.

2. The method as claimed in claim 1, further comprising:
obtaining a sliding direction and the sliding distance according to the sliding track; and
moving all of the characters in an array of keys in the user interface to corresponding positions in accordance with the sliding direction and the sliding distance, and filling characters overflowing to the outside of the array of keys in rows or columns of vacant keys of the array.

3. The method as claimed in claim 2, wherein the characters overflowing to the outside of the array of keys are out-of-order filled in the rows or columns of vacant keys of the array.

4. The method as claimed in claim 1, further comprising:
exchanging characters of a row or a column in which the starting point is located for characters of another row or another column in which the ending point is located.

5. A computer-implemented method, executable by a processor of an electronic device with a touch screen, the method comprising:
detecting an i-th sliding operation on the touch screen, wherein 1≦i≦n;
obtaining an i-th set of unlocking sub-password by analyzing a starting point, a sliding track and an ending point of the i-th sliding operation, wherein the i-th set of unlocking sub-password comprises a character corresponding to a key at the starting point and a sliding distance corresponding to the i-th sliding operation;
comparing the i-th set of unlocking sub-password with a preset i-th set of standard sub-password;
determining whether the comparison result is the same;
determining whether i<n when the comparison result is the same;
detecting a next i-th sliding operation when i<n; and
unlocking an user interface of the electronic device when i is equal to n.

6. The method as claimed in claim 5, further comprising:
obtaining a sliding direction and the sliding distance according to the sliding track; and
moving all of the characters in an array of keys in the user interface to corresponding positions in accordance with the sliding direction and the sliding distance, and filling characters overflowing to the outside of the array of keys in rows or columns of vacant keys of the array.

7. The method as claimed in claim 6, wherein the characters overflowing to the outside of the array of keys are out-of-order filled in the rows or columns of vacant keys of the array.

8. The method as claimed in claim 5, further comprising:
exchanging characters of a row or a column in which the starting point is located for characters of another row or another column in which the ending point is located.

9. An electronic device, the electronic device comprising:
a touch screen;
at least one processor;
memory storing instructions,
wherein the instructions are executed on the processor to cause the processor to:
detect an i-th sliding operation on the touch screen, wherein 1≦i≦n;
obtain an i-th set of unlocking sub-password by analyzing a starting point, a sliding track and an ending point of the i-th sliding operation, wherein the i-th set of unlocking sub-password comprises a character corresponding to a key at the starting point and a sliding distance corresponding to the i-th sliding operation;
store the i-th set of unlocking sub-password until no sliding operation is detected within a predetermined time interval, to obtain I sets of unlocking sub-passwords in sequence;
compare whether the obtained I sets of unlocking sub-passwords are the same with preset N sets of standard sub-passwords; and
unlock an user interface of the electronic device when the comparison result is the same.

10. The electronic device as claimed in claim 9, wherein the instructions executed on the processor further causes the processor to:
obtain a sliding direction and the sliding distance according to the sliding track;
move all of the characters in an array of keys in the user interface to corresponding positions in accordance with the sliding direction and the sliding distance, and fill characters overflowing to the outside of the array of keys in rows or columns of vacant keys of the array.

11. The electronic device as claimed in claim 10, wherein the characters overflowing to the outside of the array of keys are out-of-order filled in the rows or columns of vacant keys of the array.

12. The electronic device as claimed in claim 9, wherein the instructions executed on the processor further causes the processor to:
exchange characters of a row or a column in which the starting point is located for characters of another row or another column in which the ending point is located.

13. An electronic device, the electronic device comprising:
a touch screen;
at least one processor;
memory storing instructions,
wherein the instructions are executed on the processor to cause the processor to:
detect an i-th sliding operation on the touch screen, wherein 1≦i≦n;
obtain an i-th set of unlocking sub-password by analyzing a starting point, a sliding track and an ending point of the i-th sliding operation., wherein the i-th set of unlocking sub-password comprises a character corresponding to a key at the starting point and a sliding distance corresponding to the i-th sliding operation;
compare the i-th set of unlocking sub-password with a preset i-th set of standard sub-password;
determine whether the comparison result is the same;
determine whether i<n when the comparison result is the same;
detect a next i-th sliding operation when i<n; and
unlock an user interface of the electronic device when i is equal to n.

14. The electronic device as claimed in claim 13, wherein the instructions executed on the processor further causes the processor to:
obtain a sliding direction and the sliding distance according to the sliding track; and
move all of the characters in an array of keys in the user interface to corresponding positions in accordance with the sliding direction and the sliding distance, and fill characters overflowing to the outside of the array of keys in rows or columns of vacant keys of the array.

15. The electronic device as claimed in claim 14, wherein the characters overflowing to the outside of the array of keys are out-of-order filled in the rows or columns of vacant keys of the array.

16. The electronic device as claimed in claim 13, wherein the instructions executed on the processor further causes the processor to:
exchange characters of a row or a column in which the starting point is located for characters of another row or another column in which the ending point is located.
